(19) United States
(12) Patent Application Publication
(10) Pub. No.: US 2015/0229957 A1
(43) Pub. Date: Aug. 13, 2015

(54) DEPTH MAP CODING

(71) Applicants: Xin ZHAO, Beijing (CN); Li ZHANG, San Diego, CA (US); Ying CHEN, San Diego, CA (US); Marta KARCZEWICZ, San Diego, CA (US); QUALCOMM INCORPORATED, San Diego, CA (US)

(72) Inventors: Xin Zhao, San Diego, CA (US); Li Zhang, San Diego, CA (US); Ying Chen, San Diego, CA (US); Marta Karczewicz, San Diego, CA (US)

(73) Assignee: QUALCOMM Incorporated, San Diego, CA (US)

(21) Appl. No.: 14/427,077

(22) PCT Filed: Sep. 24, 2012
(86) PCT No.: PCT/CN2012/001296

§ 371 Date: Mar. 10, 2015

(51) Int. Cl. H04N 19/55; H04N 19/70; H04N 19/593; H04N 19/61; H04N 19/44; H04N 19/43

(52) U.S. Cl. CPC H04N 19/55; H04N 19/44; H04N 19/43; H04N 19/593; H04N 19/619; H04N 19/70

(57) ABSTRACT

During a coding process, systems, methods, and apparatus may code data representative of the positions of elements of a chain that partitions a prediction unit of video data. Some examples may include generating the data representative of the positions of elements of a chain that partitions a prediction unit of video data. Each of the positions of the elements except for a last element may be within the prediction unit. The position of the last element may be outside the prediction unit. This can indicate that the penultimate element is the last element of the chain. Some examples may code the partitions of the prediction unit based on the chain.

### TECHNICAL FIELD

This disclosure relates to video coding and, more particularly, to methods and apparatus for encoding and decoding video data.

### BACKGROUND

Digital video capabilities may be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into blocks. Each block may be further partitioned. Blocks in an intra-coded (I) frame or slice are encoded using spatial prediction with respect to neighboring blocks. Blocks in an inter-coded (P or B) frame or slice may use spatial prediction with respect to neighboring blocks in the same frame or slice or temporal prediction with respect to other reference frames.

### SUMMARY

In one example, the disclosure describes a method that includes coding data representative of positions of elements of a chain that partitions a prediction unit of video data, wherein each of the positions of the elements except for a last element is within the prediction unit, and wherein the position of the last element is outside the prediction unit to indicate that the penultimate element is the last element of the chain and coding the partitions of the prediction unit based on the chain.

In another example, the disclosure describes a device that includes a video coder for coding video data including one or more processors configured to code data representative of positions of elements of a chain that partitions a prediction unit of video data, wherein each of the positions of the elements except for a last element is within the prediction unit and wherein the position of the last element is outside the prediction unit to indicate that the penultimate element is the last element of the chain; and code the partitions of the prediction unit based on the chain.

In another example, the disclosure describes an apparatus for coding video data including means for coding data representative of positions of elements of a chain that partitions a prediction unit of video data, wherein each of the positions of the elements except for a last element is within the prediction unit, and wherein the position of the last element is outside the prediction unit to indicate that the penultimate element is the last element of the chain and means for coding the partitions of the prediction unit based on the chain.

In another example, the disclosure describes a computer-readable storage medium. The computer-readable storage medium having stored thereon instructions that upon execution cause one or more processors of a device to perform the following steps code data representative of positions of elements of a chain that partitions a prediction unit of video data, wherein each of the positions of the elements except for a last element is within the prediction unit, and wherein the position of the last element is outside the prediction unit to indicate that the penultimate element is the last element of the chain and code the partitions of the prediction unit based on the chain.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram that illustrates an example multimedia encoding and decoding system.

FIG. 2 is a block diagram illustrating an example of a video encoder that may implement techniques for coding data representative of the positions of elements of a chain that partitions a prediction unit of video data in accordance with one or more examples described in this disclosure.

FIG. 3 is a block diagram illustrating an example of a video decoder that may implement techniques for coding data representative of the positions of elements of a chain that partitions a prediction unit of video data in accordance with one or more examples described in this disclosure.

FIG. 4 is a diagram illustrating an example of angular prediction.

FIG. 5 is a diagram illustrating a wedgelet pattern for an 8×8 block.

FIG. 6 is a diagram illustrating two irregular regions for an 8×8 block.

FIG. 7 is a diagram illustrating one possible direction index 500 for a chain code.

FIG. 8 illustrates and example depth PU including a partition pattern.

FIG. 9 illustrates and example depth PU including a partition pattern.

FIG. 10 is a flowchart illustrating an example method in accordance with one or more examples described in this disclosure.

FIG. 11 is a flowchart illustrating a decoding process of a PU coded by chain coding.

FIG. 12 is a flowchart illustrating the derivation of the last chain position in chain coding.

FIG. 13 is another flowchart illustrating an example method in accordance with one or more examples described in this disclosure.

### DETAILED DESCRIPTION

The attached drawings illustrate examples. Elements indicated by reference numbers in the attached drawings correspond to elements indicated by like reference numbers in the following description. In the attached drawings, ellipses indicate the presence of one or more elements similar to those separated by the ellipses. Alphabetical suffixes on reference numbers for similar elements are not intended to indicate the presence of particular numbers of the elements. In this disclosure, elements having names that start with ordinal words (e.g., “first,” “second,” “third,” and so) do not necessarily imply that the elements have a particular order. Rather, such ordinal words may merely be used to refer to different elements of the same or similar kind.

A picture of video data is associated with one or more blocks of samples. In this disclosure, the term “sample” may refer to a value defining a component of a block, such as a luma or a chroma component of the pixel. Each sample block of the picture can specify different components of the pixels in the picture.

An encoder may first partition a picture into “slices.” A slice is a term used generally to refer to independently decodable portions of the picture. The encoder may next partition these slices into “treeblocks,” also referred to as “coding tree units.” A treeblock may also be referred to as a largest coding unit (LCU). The encoder may partition each of the treeblocks into a hierarchy of progressively smaller coding units (CUs), which when illustrated may be represented as a hierarchical tree structure, hence the name “treeblocks.” Partitioning treeblocks in this way may enable the encoder to capture motion of different sizes. Each undivided sample block corresponds to a different coding unit (CU). For ease of explanation, this disclosure may refer to the sample block corresponding to a CU as the sample block of the CU.

The encoder can generate one or more prediction units (PUs) for each of the CUs. The encoder can generate the PUs for a CU by partitioning the sample block of the CU into prediction areas. The encoder may then perform a contour partitioning operation with respect each PU of the CU. For example, the encoder might use a contour partitioning when a PU can be partitioned into two irregular regions.

In an example, a video coder performing contour partitioning may involve chain coding. For example, an encoder or decoder using chain coding may code data representative of a starting edge. The encoder or decoder may also code a chain starting position along the chain starting edge. The encoder or decoder may also code a chain code word for each element in the prediction unit, such as a video prediction unit and an additional chain code word corresponding to a coordinate outside a boundary of the prediction unit.

In one example, a video coder may code data representative of the positions of elements of a chain that partitions a prediction unit of video data. Some examples may include generating the data representative of the positions of elements of a chain that partitions a prediction unit of video data. Each of the positions of the elements except for a last element may be within the prediction unit. The position of the last element may be outside the prediction unit. This can indicate that the penultimate coded element is the last element of the chain. That is, the position of an element of the chain being outside the prediction unit may indicate that the element is the last element of the chain. For example, a video encoder may determine that the chain is to end at a particular element at an edge of the prediction unit, and code a final element of the chain as being outside the prediction unit. Likewise, a video decoder may determine, after coding an element of a chain that has a position outside the prediction unit, that the chain has ended. Some examples may code the partitions of the prediction unit based on the chain.

Some examples described herein provide for deriving the number of elements in a chain rather than signaling the number of elements in the chain. Conventionally, signaling the total number of elements in a chain uses log₂N+1 bits for an N×N PU. However, using the techniques of this disclosure, the number of elements may be removed from the bitstream, which may reduce signaling overhead. One additional element may be parsed. That additional element may corresponding to a coordinate outside the boundary of the PU. In the example, generally in the decoder, the coordinates (x, y) of each current element may be tracked during and after the parsing of each chain code such that the decoder may determine when the last element has been parsed. When an element's coordinates, after parsing a chain code, is out of the boundary of the PU and the current parsed number of chains is large than 1, the parsing of chain codes terminates.

Some examples, provide for a partition pattern that might only intersect with either top or left boundary. Other examples provide for partition patterns that might intersect with a top boundary, bottom boundary, right boundary, or left boundary. Two bits may be used to signal whether a chain starts from top (e.g., 00), left (e.g., 01), bottom (e.g., 10) or right (e.g., 11) boundaries of the prediction unit. Still other examples might provide for partition patterns that intersect some subset of these. In some examples, when the chains start from bottom, the start position may be initialized in the same way as the chains start from top, and the decoded partition pattern is flipped up and down. When the chains start from right, the start position may be initialized in the same way as the chains start from left, and the decoded partition pattern is flipped right and left.

Alternatively, 1 bit might be used to indicate starting from the left and 2-bits may be used to indicate starting either from the top or bottom. For example, 0 may indicate a left boundary starting position, 10 may indicate a top boundary starting position, and 11 may indicate a bottom boundary starting position. In some cases, when starting from bottom, the chains may end at the right boundary of a PU. For example, in such a case, the video coder may be configured to determine that if the chain starts from the bottom boundary, the chain ends at the right boundary of the PU. In other examples, the video coder may be configured to determine that if the chain starts from the top boundary, the chain ends at the right boundary of the PU. Other combinations of boundary starting and ending locations are also possible, such as starting from the bottom and ending at either boundary or starting from the top boundary and ending at either boundary.

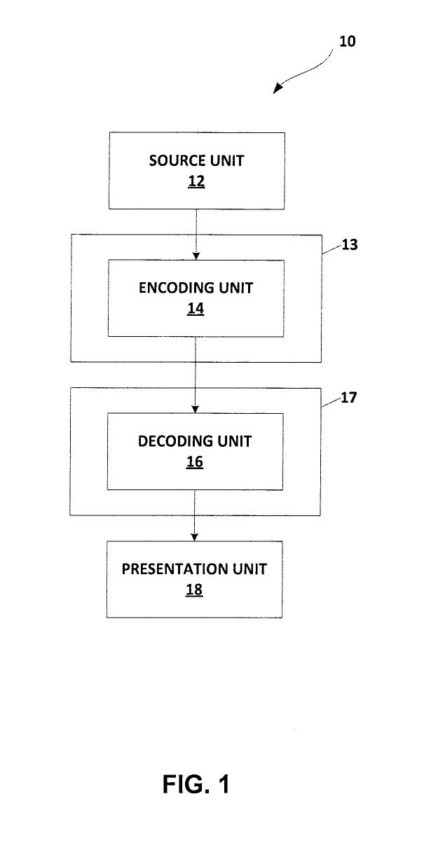

FIG. 1 is a block diagram that illustrates an example multimedia encoding and decoding system 10. Multimedia encoding and decoding system 10 captures video data, encodes the captured video data, transmits the encoded video data, decodes the encoded video data, and then plays back the decoded video data.

Multimedia encoding and decoding system 10 comprises a source unit 12, an encoding unit 14, a decoding unit 16, and a presentation unit 18. Source unit 12 generates video data. Encoding unit 14 encodes the video data. Decoding unit 16 decodes the encoded video data. Presentation unit 18 presents the decoded video data.

One or more computing devices implement source unit 12, encoding unit 14, decoding unit 16, and presentation unit 18. In this disclosure, the term computing device encompasses physical devices that process information. Example types of computing devices include personal computers, laptop computers, mobile telephones, smartphones, tablet computers, in-car computers, television set-top boxes, video conferencing systems, video production equipment, video cameras, video game consoles, or others types of devices that process information.

In some examples, a single computing device may implement two or more of source unit 12, encoding unit 14, decoding unit 16, and presentation unit 18. For example, a single computing device may implement source unit 12 and encoding unit 14. In this example, another computing device may implement decoding unit 16 and presentation unit 18. In other examples, different computing devices implement source unit 12, encoding unit 14, decoding unit 16, and presentation unit 18.

In the example of FIG. 1, a computing device 13 implements encoding unit 14 and a computing device 17 implements decoding unit 16. In some examples, computing device 13 may provide functionality in addition to encoding unit 14. Furthermore, in some examples, computing device 17 may provide functionality in addition to decoding unit 16.

In some examples encoding device 14 may encode data representative of positions of elements of a chain. These position elements make up the chain that may partition a prediction unit of video data. In other words, the elements collectively form a chain that partitions the prediction unit. Each of the positions of the elements except for a last element may be within the prediction unit. The position of the last element is outside the prediction unit to indicate that the penultimate element is the last element of the chain. Encoding unit 14 may encode the partitions of the prediction unit based on the chain. Particularly, for intra-prediction coding, encoding unit 14 may determine different intra-prediction coding modes for the first and second partitions of the partitioned prediction unit. Moreover, encoding unit 14 may provide separate indications of the intra-prediction modes for each of the partitions, predict each partition using the respective intra-prediction mode, combine the two partitions using a partition map. For example, all values that correspond to “0” may be overlaid with the values from first partition block. All the values that have a value of “1” may be overlaid with the values from the second partition block. Encoding unit 14 may use this combined block to calculate a difference to determine a residual. The block may then be transformed and quantized and CABAC coded.

Similarly, decoding unit 16 may decode the data representative of positions of elements of a chain that partitions a prediction unit of video data. Again, each of the positions of the elements except for a last element may be within the prediction unit and the position of the last element may be outside the prediction unit to indicate that the last element is the last element of the chain. Accordingly, decoding unit 16 may decode the partitions of the prediction unit based on the chain. Particularly, for intra-prediction coding, decoding unit 16 may decode values indicating what the different intra-prediction coding modes are for the first and second partitions of the partitioned prediction unit. Moreover, decoding unit 16 may provide separate indications of the intra-prediction modes for each of the partitions, predict each partition using the respective intra-prediction mode, and combine the two partitions using a partition map. More specifically, decoding unit 16 may CABAC decode quantized transform coefficients, inverse-transform and inverse-quantize the residual block, and add the residual back into the PU. Additionally, the decoding unit 16 may determine intra-modes for partitioning the PU and decode data representing chain elements and partition the PU using chain coding mode. In this way the original block may be reproduced.

As mentioned briefly above, source unit 12 generates video data that represent a series of pictures. A picture is also commonly referred to as a “picture.” When the series of pictures in the video data are presented to a user in rapid succession (e.g., 24 or 25 pictures per second), the user may perceive objects in the pictures to be in motion.

In various examples, source unit 12 generates the video data in various ways. For example, source unit 12 may comprise a video camera. In this example, the video camera captures images from a visible environment. In another example, source unit 12 may comprise one or more sensors for medical, industrial, or scientific imaging. Such sensors may include x-ray detectors, magnetic resonance imaging sensors, particle detectors, and so on. In yet another example, source unit 12 may comprise an animation system. In this example, one or more users use the animation system to draw, draft, program, or otherwise design the content of the video data from their imaginations.

Encoding unit 14 receives the video data generated by source unit 12. Encoding unit 14 encodes the video data such that less data represents the series of pictures in the video data. In some instances, encoding the video data in this way may be necessary to ensure that the video data may be stored on a given type of computer-readable media, such as a DVD or CD-ROM. Furthermore, in some instances, encoding the video data in this way may be necessary to ensure that the video data may be efficiently transmitted over a communication network, such as the Internet.

Encoding unit 14 may encode video data, which is often expressed as a sequence or series of video pictures. Encoding unit 14 may split these pictures into independently decodable portions (which are commonly referred to as “slices”), which in turn, encoding unit 14 may split into treeblocks. These treeblocks may undergo a form of recursive hierarchical quadtree splitting. Encoding unit 14 may perform this splitting to generate a hierarchical tree-like data structure, with the root node being the treeblock. Each undivided sample block within a treeblock corresponds to a different CU. The CU of an undivided sample block may contain information, including motion information and transform information, regarding the undivided sample block.

While various examples may be applied to 2D video coding, generally the example systems and methods described herein relate to 3D video coding. The various coding techniques may be based on advanced codecs, including depth-coding techniques. Some example proposed depth coding techniques are related to depth map intra coding.

Some example video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. The latest joint draft of MVC is described in “Advanced video coding for generic audiovisual services,” ITU-T Recommendation H.264, March 2010, hereby incorporated by reference.

In addition, there is a video coding standard, generally referred to as the High Efficiency Video Coding (HEVC), being developed by the Joint Collaboration Team on Video Coding (JCT-VC) of ITU-T Video Coding Experts Group (VCEG) and ISO/IEC Motion Picture Experts Group (MPEG). A recent draft of HEVC is available at: http://phenix.it-sudparis.eu/jct/doc_end_user/documents/10_Stockholm/wg11/JCTVC-J1003-v8.zip

HEVC may use blocks of up to 64×64 pixels. Such an arrangement may better sub-partition the picture into variable sized structures. For example, HEVC may initially divide a picture into coding tree units (CTUs) which may then divided for each luma/chroma component into coding tree blocks (CTBs). A CTB can be 64×64, 32×32, or 16×16, for example. A larger block size may usually increase the coding efficiency. CTBs are than divided into coding units (CUs).

The arrangement of CUs within a CTB may be referred to as a quadtree since a subdivision results in four smaller regions. CUs may then be divided into prediction unit (PUs) of either intra-picture or inter-picture prediction type, which can vary in size from 64×64 to 4×4. The prediction residual may then be coded using transform units (TUs) which contain coefficients for spatial block transform and quantization. A TU can be 32×32, 16×16, 8×8, or 4×4. In some examples, HEVC may use a luma component for each PU.

HEVC may also use an intra-prediction coding method that utilized angular prediction. Angular prediction is an example method of direction prediction. In the angular mode, a system may provide a prediction direction by providing one of a series of possible modes that indicate an angle. These angles may indicate a displacement of the bottom row of a block and a reference row above the block in the case of vertical prediction, or displacement of a rightmost column of the block and reference column left from the block in the case of the horizontal prediction. The displacement may be signaled at 1 pixel accuracy. When projection of the predicted pixel falls in between reference samples, the predicted value for the pixel may be linearly interpolated from the reference samples.

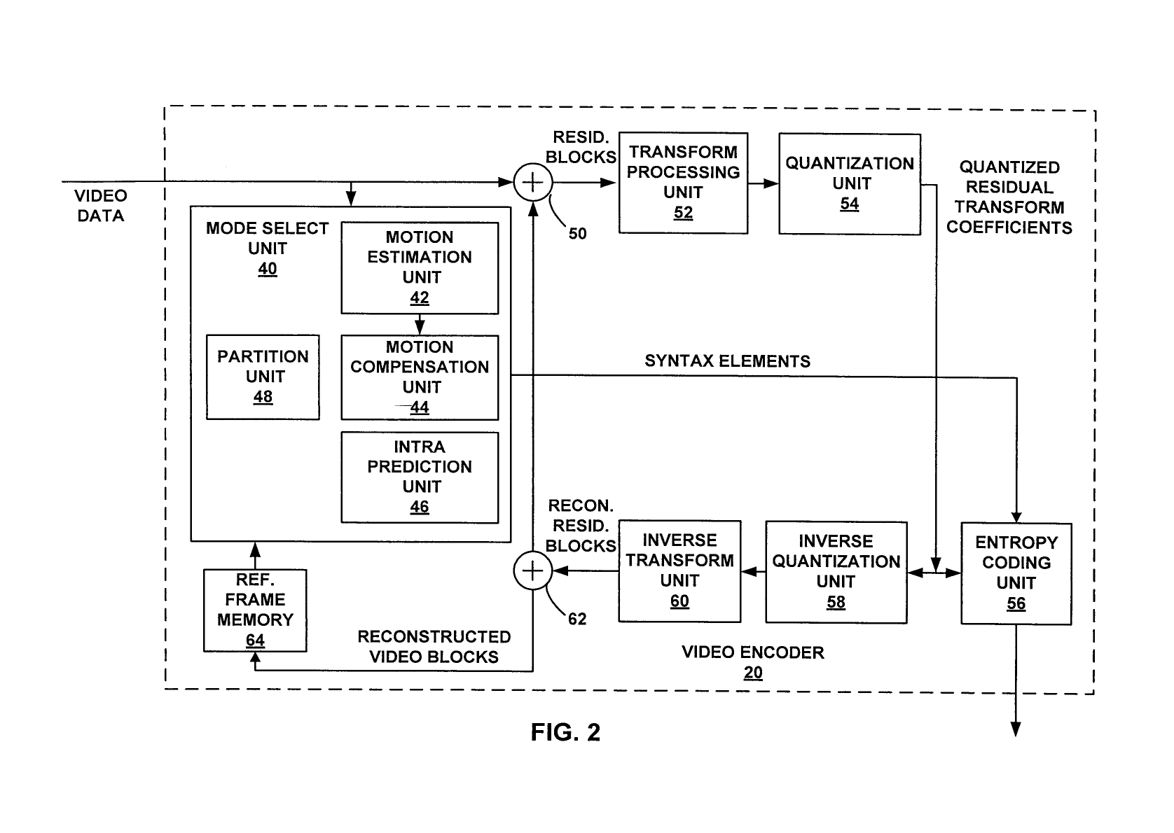

FIG. 2 is a block diagram illustrating an example of video encoder 20 that may implement techniques for coding data representative of the positions of elements of a chain that partitions a prediction unit of video data in accordance with one or more examples described in this disclosure. In one example, the video encoding unit 14 of FIG. 1 may be a video encoder 20. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

As shown in FIG. 2, video encoder 20 receives a current video block within a video picture to be encoded. In the example of FIG. 2, video encoder 20 includes mode select unit 40, reference frame memory 64, summer 50, transform processing unit 52, quantization unit 54, and entropy coding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video picture or slice to be coded. The picture or slice may be divided into multiple video blocks. Motion estimation unit 42 and motion compensation unit 44 perform inter-predictive coding of the received video block relative to one or more blocks in one or more reference pictures to provide temporal compression. Intra-prediction unit 46 may alternatively perform intra-predictive coding of the received video block relative to one or more neighboring blocks in the same picture or slice as the block to be coded to provide spatial compression. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a picture or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference picture. Mode select unit 40 also provides syntax elements, such as motion vectors, intra-mode indicators, partition information, and other such syntax information, to entropy coding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture (or other coded unit) relative to the current block being coded within the current picture (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy coding unit 56. Entropy coding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block including residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy coding unit 56 entropy codes the quantized transform coefficients. For example, entropy coding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy coding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video picture.

In this manner, video encoder 20 of FIG. 2 represents an example of a video encoder configured to code data representative of positions of elements of a chain. The chain may partition a prediction unit of video data. Additionally, each of the positions of the elements except for a last element may be within the prediction unit. The position of the last element may be outside the prediction unit to indicate that the penultimate element is the last element of the chain. Video encoder 20 may also code the partitions of the prediction unit based on the chain.

In an example, mode select unit 40 may select the chain coding mode for a depth PU. Video encoder 20, using chain coding, may encode data representative of a starting edge. The video encoder 20 may also encode a chain starting position along the chain starting edge. The video encoder 20 may also code a chain code word for each element in the prediction unit, such as a video prediction unit and an additional chain code word corresponding to a coordinate outside a boundary of the prediction unit.

Additionally, in an example, partition unit 48 partitions the PU using a chain. For example, a depth block may be partitioned into two regions by a straight line. Mode select unit 40 may determine intra-prediction modes for the partitions of the PU.

In this example, intra-prediction unit 46 may generate predicted values for the PU based on the chain and the intra-prediction modes. Moreover, data representative of the chain may be sent as syntax elements to entropy coding unit 56, which codes the syntax elements using CABAC. Intra-prediction unit 46 also sends the PU to summer 50 for forming a residual block.

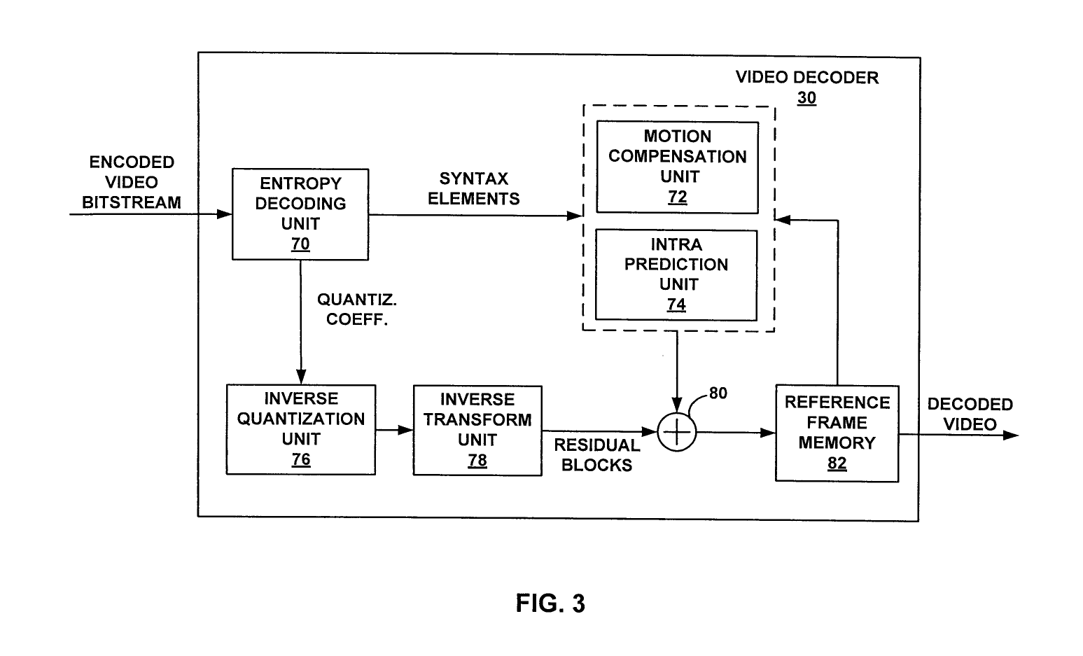

FIG. 3 is a block diagram illustrating an example of video decoder 30 that may implement techniques for coding data representative of the positions of elements of a chain that partitions a prediction unit of video data in accordance with one or more examples described in this disclosure. In one example, the video decoding unit 16 of FIG. 1 may be a video encoder 20. In the example of FIG. 3, video decoder 30 includes an entropy decoding unit 70, motion compensation unit 72, intra prediction unit 74, inverse quantization unit 76, inverse transformation unit 78, reference picture memory 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video picture is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference picture lists, List 0 and List 1, using default construction techniques based on reference pictures stored in reference picture memory 92.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, video decoder 30 forms a decoded video block by summing the residual blocks from inverse transform unit 78 with the corresponding predictive blocks generated by motion compensation unit 82. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference frame memory 82, which stores reference pictures used for subsequent motion compensation. Reference frame memory 82 also stores decoded video for later presentation on a display device, such as display device 32 of FIG. 1.

In this manner, video decoder 30 of FIG. 3 represents an example of a video decoder configured to code data representative of positions of elements of a chain. The chain may partition a prediction unit of video data. Additionally, each of the positions of the elements except for a last element may be within the prediction unit. The position of the last element may be outside the prediction unit to indicate that the penultimate element is the last element of the chain. Video decoder 30 may also code the partitions of the prediction unit based on the chain.

In an example, chain coding mode for a depth PU may be determined within video decoder 30. Video decoder 30, using chain coding, may decode data representative of a starting edge. The video decoder 30 may also decode a chain starting position along the chain starting edge. The video decoder 30 may also decode a chain code word for each element in the prediction unit, such as a video prediction unit and an additional chain code word corresponding to a coordinate outside a boundary of the prediction unit.

Additionally, the intra-prediction unit 74 may calculate predicted values for the partitions, using the chain to determine where the partitions are and indications of intra-prediction modes to calculate predicted values for the partitions. Mode select unit 40 may determine intra-prediction modes for the partitions of the PU.

In this example, intra-prediction unit 74 may generate predicted values for the PU based on the chain and the intra-prediction modes. Moreover, data representative of the chain may be received as syntax elements to entropy decoding unit 70, which decodes the syntax elements using CABAC. Intra-prediction unit 74 also sends the prediction data to summer 80 to be summed with a residual block to generate decoded video.

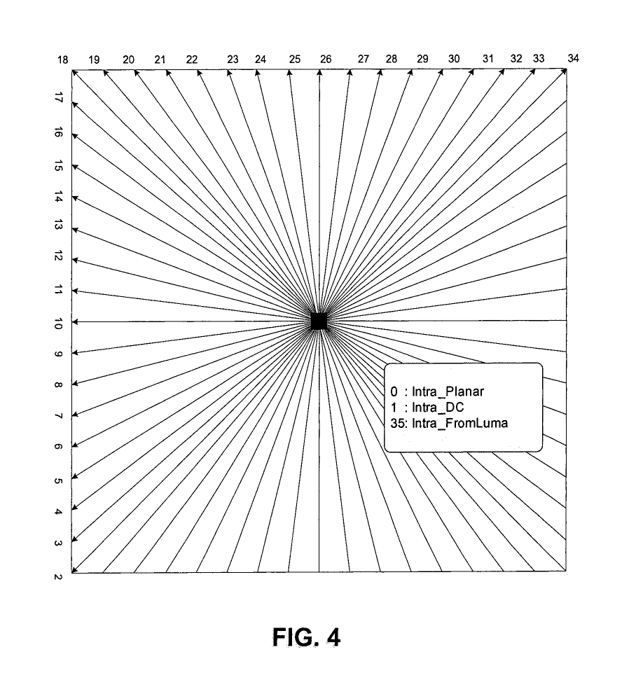

FIG. 4 is a diagram illustrating an example of angular prediction, e.g., in accordance with various corresponding intra-prediction modes. For example, the various angular prediction modes shown in FIG. 4 may be used to predict various partitions of a PU that have been partitioned in accordance with the techniques of this disclosure. For example, these angular predictions might be used in conjunction with video encoder 20 or video decoder 30. As illustrated in FIG. 4, HEVC may use an intra prediction coding method that utilizes 33 angular prediction modes (indexed from 2 to 34), in addition to non-angular prediction modes such as DC and planar prediction modes. Accordingly, a system using HEVC (such as either or both of encoding unit 14 and/or decoding unit 16 of FIG. 1) may, for example, provide a prediction direction by providing one of modes 2 to 34 that indicate an angle as illustrated in FIG. 4. In particular, in accordance with the techniques of this disclosure, a video coder may code a representation of an intra-prediction mode for each partition of a PU, partitioned using the chain coding techniques of this disclosure. HEVC may also use a DC mode (indexed with 1) and Planar mode (indexed with 0), as illustrated in FIG. 4. In 3D-HEVC, the same definition of intra prediction modes may be utilized. For example, with respect to FIG. 4, the prediction modes (e.g., indexed 2 to 34) may be used by video encoder 20 and or video decoder 30 to code values representative of the various intra prediction modes. Moreover, the two different partitions P0/P1 of a PU that result from chain coding may have different intra prediction modes. The encoder and decoder may code values representative of those different intra prediction modes for each of the two different partitions.

Some example HEVC-based 3D Video Coding (3D-HEVC) codec in MPEG may be based on the solutions proposed in m22570 and m22571. Reference software HTM version 4.0 for 3D-HEVC can be downloaded from the following link: [HTM-4.0]:https://hevc.hhi.fraunhofer.de/svn/svn_{—}3DVCSoftware/tags/HTM-4.0. A software description (document number: w12774) is available from: http://wg11.sc29.org/doc_end_user/documents/100_Geneva/wg11/w12744-v2-w12744.zip.

In 3D-HEVC, each access unit may contain multiple view components, each contains a unique view identification (ID), or view order index, or layer ID. A view component contains a texture view component as well as a depth view component. A system using HVEC may code a texture view component as one or more texture slices, while the depth view component is coded as one or more depth slices. In an example, one depth block's attributes may be inherited from another co-located block. For example, the luma of a depth block may inherit the intra-prediction direction from a co-located luma block. Additionally, “co-located” may mean that the position of the luma block is scaled, based on a difference in pixel resolution between the luma picture and the depth picture.

Some examples may use depth map coding in 3D video coding. In such an example, 3D video data may be represented using the multiview video plus depth format, in which captured views (texture) are associated with corresponding depth maps. In 3D video coding, textures and depth maps are coded and multiplexed into a 3D video bitstream. Depth maps are coded as a grayscale video where the luma samples represent the depth values, and conventional intra- and inter-coding methods can be applied for depth map coding.

Depth maps may be characterized by sharp edges and constant areas, and edges in depth map always present strong correlations with corresponding texture. Due to the different statistics and correlations between texture and corresponding depth, different coding schemes are designed for depth maps based on a 2D video codec. In 3D-HEVC, Depth Modeling Modes (DMMs) may be introduced together with the HEVC intra prediction modes to code an Intra prediction unit of a depth slice.

For better representations of sharp edges in depth maps, HTM version 4.0 applies a Depth Modeling Mode (DMM) method for intra coding of depth map. There are four new intra modes in DMM. In all four modes, a depth block may be partitioned into two regions specified by a DMM pattern, where each region is represented by a constant value. The DMM pattern can be either explicitly signaled (mode 1), predicted by spatially neighboring blocks (mode 2), or predicted by co-located texture block (mode 3 and mode 4). There are two partitioning models defined in DMM, including wedgelet partitioning and the contour partitioning. The techniques of this disclosure may be used in the contour partitioning model.

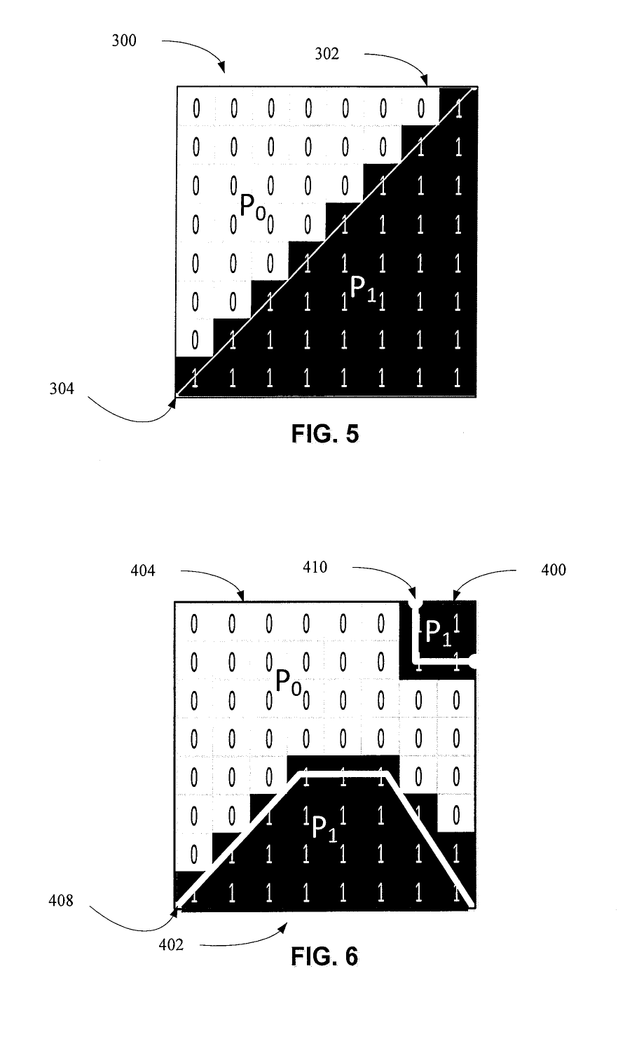

FIG. 5 is a diagram illustrating a wedgelet pattern 300 for an 8×8 block 302. In some examples, wedgelet pattern 300 might be processed in units such as either or both of encoding unit 14 and/or decoding unit 16 of FIG. 1. For a wedgelet partition, a depth block may be partitioned into two regions, P₀ and P₁, by a straight line 304, as illustrated in FIG. 5. Wedgelets may be used as approximations to potentially more efficiently approximate images. As illustrated in FIG. 5, these approximations may be obtained by partitioning block 302 into two regions, P₀ and P₁, that form two sets of numbers (e.g., P₀ having a series of “0's” indicating “white” and P₁ having a series of “1's” indicating “black”). It will be understood that other colors may also be indicated by the sets of numbers. Accordingly, in some examples, the block 302 may be defined by line 304. Accordingly, data related to line 304 might be transmitted instead of transmitting data related to all 64 pixels in the 8×8 block 302. Block 302 may be generated from just the location of the line 304 and the color on each side of the line. Generally, for some shapes, such as wedgelet pattern 300 for an 8×8 block 302, the data needed to represent the pattern may be less than the data needed to represent all 64 pixels individually. Accordingly, fewer bits might be transmitted, e.g., using the techniques of this disclosure.

FIG. 6 is a diagram illustrating two irregular regions 400, 402 for an 8×8 block 406. For an irregular region 400, 402, a depth block 406 may be partitioned into two regions, P₀ and P₁, by lines 408, 410, as illustrated in FIG. 6. Similar to the wedgelets described with respect to FIG. 5, the two irregular regions 400, 402 for the 8×8 block 406 may be used as an approximation to potentially more efficiently approximate images including block 406. As illustrated in FIG. 6, these approximations may be obtained by partitioning block 404 into two regions, P₀ and P₁, that are not contiguous. The two regions, P₀ and P₁ form two sets of numbers (e.g., P₀ having a series of “0's” indicating “white” and P₁ having a series of “1's” indicating “black”). It will be understood that other colors may also be indicated by the sets of numbers. Accordingly, in some examples, the block 406 may be defined by lines 408 and 410. Accordingly, data related to lines 408 and 410 might be transmitted instead of transmitting data related to all 64 pixels in the 8×8 block 406. Block 406 may be generated from just the location of the lines 408 and 410 and the color on each of the two regions, P₀ and P₁. Generally, for some shapes such as the two irregular regions P₀ and P₁ for the 8×8 block 406, the data needed to represent the pattern may be less than the data needed to represent all 64 individual pixels individually. Accordingly, fewer bits might be transmitted, e.g., using the techniques of this disclosure.

For a contour partitioning, the depth block 406 may be partitioned into two irregular regions 400, 402, as shown in FIG. 6. In some examples, irregular regions 400, 402 might be processed in units such as either or both of encoding unit 14 and/or decoding unit 16 of FIG. 1. The contour partitioning is more flexible than the Wedgelet partitioning, but may be difficult to signal. In DMM mode 4, contour partitioning pattern may be implicitly derived using reconstructed luma samples of the co-located texture block. The DMM method is integrated as an alternative to the intra prediction modes specified in HEVC. In an example, one bit flag may be signaled for each PU to specify whether DMM or unified intra prediction is applied.

Some examples may use region boundary chain coding mode. In 3D-HEVC, region boundary chain coding mode is introduced together with the HEVC intra prediction modes and DMM modes to code an intra prediction unit of a depth slice. For brevity, “region boundary chain coding mode” is denoted by “chain coding.”

A chain code is a compression algorithm for monochrome images. Chain coding is lossless with respect to the chain elements. The basic principle of chain codes is to separately encode each connected component in the image. For example, as illustrated in FIGS. 5 and 6, regions P₁ might be encoded. Accordingly, for these region P₁, a point on the boundary may be selected and its coordinates may be transmitted. The encoder then moves along the boundary of the region and, at each step, transmits a symbol representing the direction of this movement. This may continue until the encoder returns to the starting position if a region is contained within a block or until an edge is reached when a region touches the edges of a block or is contained within a block, e.g., as illustrated in FIG. 6. In some cases, the process may be repeated to code multiple regions P₁ within a block. This encoding method may be particularly effective for images consisting of a reasonably small number of large connected components. It will be understood that, in another example, P₀ might be encoded rather P₁ than region

In an example, a chain coding of a PU may be signaled. For example, the techniques of the current disclosure may be used in conjunction with the PU illustrated in FIG. 5. These techniques will generally not be applied to the PU illustrated in FIG. 6, however. In some examples, when chain coding is used a starting position of the chain, the number of the chain codes, and a direction index for each chain element may be signaled. In a number of examples, however, the number of the chain codes may be derived, e.g., at a receiver, rather than signaled. In examples that do not signal the number of chain codes the number of bits that a transmitter might be required to signal might be decreased.

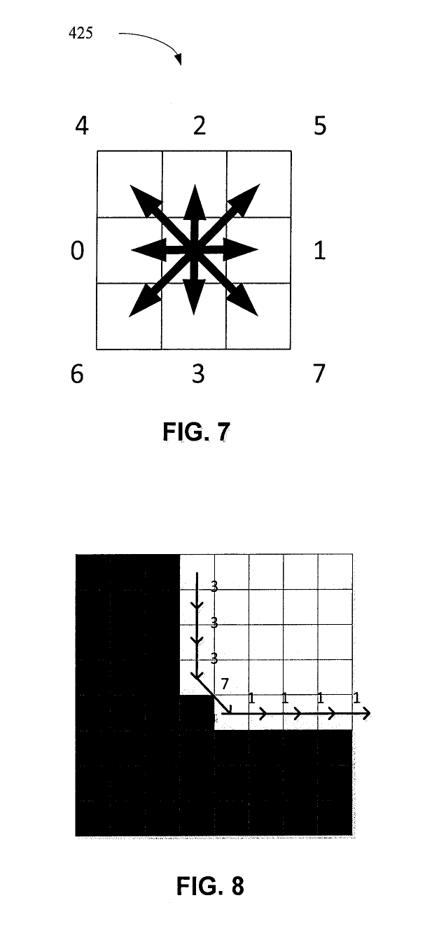

FIG. 7 is a diagram illustrating one possible direction index 425 for a chain code. For example, as illustrated in FIG. 7 a direction index value of “0” indicates that the direction from one chain element to the next chain element is to the left. In other words, to get from one chain to the next chain element, move to the left one pixel. Similarly, a direction index value of “1” indicates that the direction from one chain element to the next chain element is to the right. A direction index value of “2” indicates that the direction from one chain element to the next chain element is up. A direction index value of “3” indicates that the direction from one chain element to the next chain element is down.

As illustrated in FIG. 7, angular directions are also possible; with a direction index value of “4” indicates that the direction from one chain element to the next chain element is up and to the left, e.g., between the directions indicated by a direction index value of “0” and a direction index value of “2.” Similarly, a direction index value of “5” indicates that the direction from one chain element to the next chain element is up and to the right, e.g., between the directions indicated by a direction index value of “1” and a direction index value of “2.” A direction index value of “6” indicates that the direction from one chain element to the next chain element is down and to the left, e.g., between the directions indicated by a direction index value of “0” and a direction index value of “3.” A direction index value of “7” indicates that the direction from one chain element to the next chain element is down and to the right, e.g., between the directions indicated by a direction index value of “1” and a direction index value of “3.” Accordingly, in some examples, the direction index 425 of each chain code may be differentially coded based on the direction index of the previous chain code. In some examples, these angular directions might be used in units such as either or both of encoding unit 14 and/or decoding unit 16 of FIG. 1.

In one example, that might allow for signaling of a bit stream that does not includes the number of chain elements, chain coding may specify a partition pattern by performing the following steps:
1. A flag signaling whether the chains start from top or left The flag is set as “0” if the chains start from top, and it is set as “1” if the chains start from left. In some examples, more bits might be used to provide for the signaling of additional starting positions. For example, two bits might be used to signal whether the chains start from top boundary (e.g., 00), left boundary (e.g., 01), bottom boundary (e.g., 10) or right boundary (e.g., 11).
2. The starting point position of the chains For an N×N PU, log₂N bits are used to specify the starting position.
3. The directions of a series of connected chains, including a one additional chain element that may be parsed and the chain element corresponding to a coordinate outside the boundary of the PU. The end coordinate (x, y) of each current chain element may be tracked during and after the parsing of each chain code, when the coordinate after parsing a chain code is out of the boundary of the PU, and the current parsed number of chains is large than 1, the parsing of chain codes terminates.
4. Each chain element connects a sample (that is, a pixel) and one of its eight-connectivity samples, indexed from 0 to 7, as illustrated in FIG. 7.

These steps are discussed in more detail with respect to FIG. 8 below.

In contrast to the example described above, in another example that might allow for signaling a top boundary, bottom boundary, left boundary, and right boundary, while not providing for signaling of a bit stream that does not includes the number of chain elements, the chain coding in HTM 4.0 may specify a partition pattern by performing the following steps:
1. A flag signaling whether the chains start from top or left The flag is set as “0” if the chains start from top, and it is set as “1” if the chains start from left.
2. The starting point position of the chains For an N×N PU, log₂N bits are used to specify the starting position.
3. Number of total chain elements The maximum number of total chain elements for an N×N PU is restricted to be 2N. Therefore, log₂N+1 bits are used to signal the number of total chain elements.
4. The directions of a series of connected chain elements Each chain element connects a sample and one of its eight-connectivity samples, indexed from 0 to 7, as illustrated in FIG. 7.

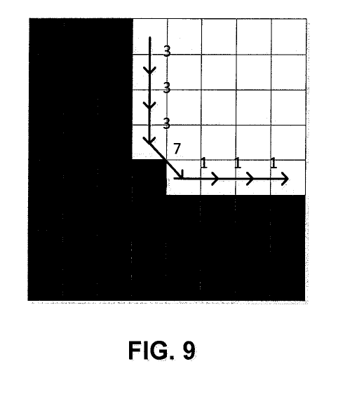

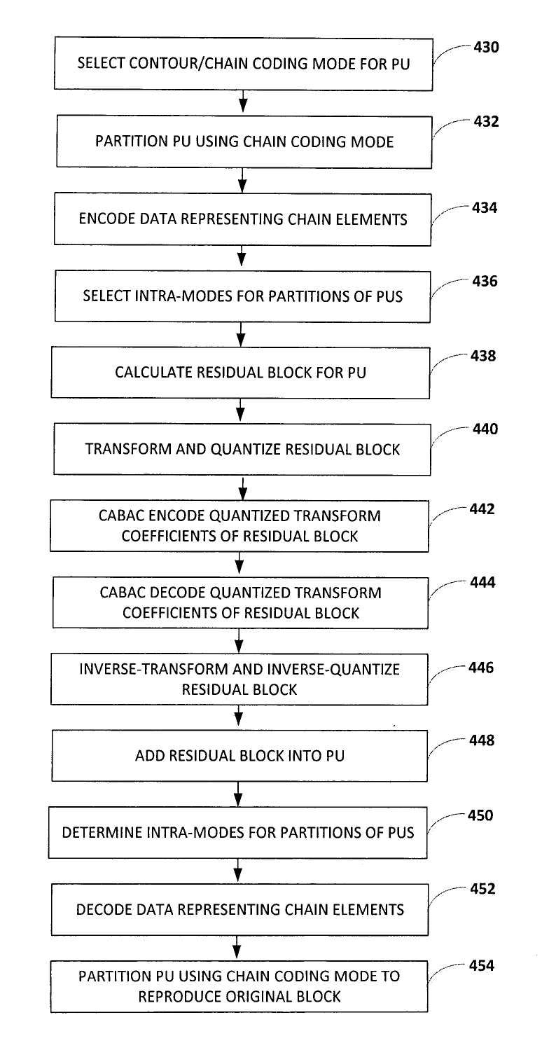

These steps are discussed in more detail with respect to FIG. 9 below.

Table 1 is a look-up table that provides for the derivation of a chain code word of a chain index. The value of the current chain index (for a current element of the chain) is indicated in Table 1 by idxCur. The value of the previous chain index (for a previous element of the chain) is indicated in Table 1 by idxPre. Accordingly, at an encoder, for each chain element, given the chains index idxCur and the chains previous chain index idxPre, the encoder may represent the movement to a subsequent chain element by a chain code word bin Cur specified by tabCode provided in Table 1. The value of the current chain index used with Table 1 and represented by idxCur is the direction index value (illustrated in FIG. 7) that indicates data representative of positions of elements of a chain that partitions a prediction unit of video data. Similarly, the value of the previous chain index used with Table 1 and represented by idxPre is the direction index value (illustrated in FIG. 7) that indicates data representative of positions of elements of a chain that partitions a prediction unit of video data. Each element of a chain may be offset by one in the ±x and/or ±y directions, as illustrated in FIG. 7. The initial value of the previous chain index used with Table 1 and represented by idxPre is the starting position of the chain.

TABLE 1
Look-up-table tabCode for deriving the
chain code word of a chain index

| idxCur | | | | | | | | |
|---|---|---|---|---|---|---|---|---|
| idxPre | 0 | 1 | 2 | 3 | 4 | 5 | 6 | 7 |
| 0 | 0 | −1 | 4 | 3 | 2 | 6 | 1 | 5 |
| 1 | −1 | 0 | 3 | 4 | 5 | 1 | 6 | 2 |
| 2 | 3 | 4 | 0 | −1 | 1 | 2 | 5 | 6 |
| 3 | 4 | 3 | −1 | 0 | 6 | 5 | 2 | 1 |
| 4 | 1 | 6 | 2 | 5 | 0 | 4 | 3 | −1 |
| 5 | 5 | 2 | 1 | 6 | 3 | 0 | −1 | 4 |
| 6 | 2 | 5 | 6 | 1 | 4 | −1 | 0 | 3 |
| 7 | 6 | 1 | 5 | 2 | −1 | 3 | 4 | 0 |

For example, a series of chain indexes is illustrated in FIG. 8. The series of chain indexes (corresponding to respective elements in the chain) are “3,” “3,” “3,” “7,” “1,” “1,” “1,” “1.” Accordingly, the elements of the example chain illustrated in FIG. 8 may have the following values: “3,” “3,” “3,” “7,” “1,” “1,” “1,” “1.” These values are illustrated in FIG. 8, which includes a series of arrows. Each arrow has an associated number next to it that indicates the direction values of FIG. 7 for that particular arrow. Similarly, a series of delayed elements of the example chain illustrated in FIG. 8 may have the following values: “3,” “3,” “3,” “3,” “7,” “1,” “1,” “1.” The first “3” in the series of delayed elements of the example chain illustrated in FIG. 8 is provided by the starting position of the chain, which is at the top, three pixels from the left, e.g., position “3.” Thus, in the example of FIG. 8, the chain code word values from Table 1 are “0,” “0,” “0,” “1,” “1,” “0,” “0,” “0,” as summarized in Table 2 below.

TABLE 2
example values from Table 1

| idxCur | 3 | 3 | 3 | 7 | 1 | 1 | 1 | 1 |
|---|---|---|---|---|---|---|---|---|
| idxPre | 3 | 3 | 3 | 3 | 7 | 1 | 1 | 1 |
| From | 0 | 0 | 0 | 1 | 1 | 0 | 0 | 0 |
| Table 1 | | | | | | | | |

Each chain code word binCur may be binarized as a sequence of binary digits using Table 3. After each chain code word is binarized, each binary digit may be encoded using an entropy-coding engine. The, values from Tables 1 and 3 for the example of FIG. 8, are summarized in Table 4 below.

TABLE 3
Binarization of each chain code word

| Chain Code | Binarization |
|---|---|
| word | digits |
| 0 | 0 |
| 1 | 10 |
| 2 | 110 |
| 3 | 1110 |
| 4 | 11110 |
| 5 | 111110 |
| 6 | 111111 |
| −1 | Not applicable |

TABLE 4
example values from Tables 1 and 3

| idxCur | 3 | 3 | 3 | 7 | 1 | 1 | 1 | 1 |
|---|---|---|---|---|---|---|---|---|
| idxPre | 3 | 3 | 3 | 3 | 7 | 1 | 1 | 1 |
| Chain Code | 0 | 0 | 0 | 1 | 1 | 0 | 0 | 0 |
| Word | | | | | | | | |
| Binarized | 0 | 0 | 0 | 10 | 10 | 0 | 0 | 0 |
| Value | | | | | | | | |

At the decoder, given the parsed chain code word bin Cur and its previous chain index idxPre, the chain index of current chain is derived using a table tabIndex illustrated in Table 5. As discussed above, the starting position of the chain, which is at the top, three pixels from the left, e.g., position “3.” The idxPre value is derived from the starting position of the chain. In this example, the first element of the chain is on the top. Other positions, such as bottom boundary, left boundary, right boundary, are also possible. Accordingly, in the example illustrated in FIG. 8, the first value of the series of delayed elements, idxPre, is a “3.”

As illustrated in Table 6, in the row “From Table 5,” the values for the chain index received at the receiver are “3,” “3,” “3,” “7,” “1,” “1,” “1,” “1”; which match the series of chain indexes value “3,” “3,” “3,” “7,” “1,” “1,” “1,” “1” from the transmitter.

TABLE 5
Look-up-table tabindex for deriving the
chain index of a chain code word

| binCur | | | | | | | |
|---|---|---|---|---|---|---|---|
| idxPre | 0 | 1 | 2 | 3 | 4 | 5 | 6 |
| 0 | 0 | 6 | 4 | 3 | 2 | 7 | 5 |
| 1 | 1 | 5 | 7 | 2 | 3 | 4 | 6 |
| 2 | 2 | 4 | 5 | 0 | 1 | 6 | 7 |
| 3 | 3 | 7 | 6 | 1 | 0 | 5 | 4 |
| 4 | 4 | 0 | 2 | 6 | 5 | 3 | 1 |
| 5 | 5 | 2 | 1 | 4 | 7 | 0 | 3 |
| 6 | 6 | 3 | 0 | 7 | 4 | 1 | 2 |
| 7 | 7 | 1 | 3 | 5 | 6 | 2 | 0 |

TABLE 6
example values from Tables 1, 3, and 5

| idxCur | 3 | 3 | 3 | 7 | 1 | 1 | 1 | 1 |
|---|---|---|---|---|---|---|---|---|
| idxPre | 3 | 3 | 3 | 3 | 7 | 1 | 1 | 1 |
| Binarized | 0 | 0 | 0 | 10 | 10 | 0 | 0 | 0 |
| Value | | | | | | | | |
| Bitstream | 0 | 0 | 0 | 1 | 1 | 0 | 0 | 0 |
| (binCur) | | | | | | | | |
| Direction to | 3 | 3 | 3 | 7 | 1 | 1 | 1 | 1 |
| Next Chain | | | | | | | | |
| ElementFrom | | | | | | | | |
| Table 5 | | | | | | | | |

In various examples, the idxPre is initialized as 3 when the chains start from top, and is initialized as 1 when the chains start from left. Other values may be used for chains that start from the bottom or right, as is discussed below.

FIG. 8 illustrates and example depth PU including a partition pattern. As illustrated in FIG. 8, the series of chain indexes are “3,” “3,” “3,” “7,” “1,” “1,” “1,” “1.” The example series (“3,” “3,” “3,” “7,” “1,” “1,” “1,” “1”) provides coding data representative of positions of elements of a chain that partitions a prediction unit of video data. Each of the positions of the elements except for a last element is within the prediction unit, (e.g., “3,” “3,” “3,” “7,” “1,” “1,” “1,”). The position of the last element (the final “1”) is outside the prediction unit to indicate that the penultimate element is the last element of the chain, as illustrated in FIG. 8. In this way, some examples described herein do not code the four bits “0111” to signal the total number of chains as 7. Rather, the receiver may determine when it has processed all of the chains by deriving the total number of chains.

For example, an encoder may chain code the example illustrated in FIG. 8 by identifying the partition pattern and encoding the following information in the bitstream:
1. One bit “0” is encoded to signal that the chains start from the top boundary
2. Three bits “011” are encoded to signal the starting position “3” at the top boundary
3. A series of connected chains indexes “3,” “3,” “3,” “7,” “1,” “1,” “1,” “1” are encoded in the bit stream. As discussed above, the encoder may convert each chain index to a code word using the look-up-table in Table 1. The last “1” provides an additional chain that the decoder may parse. The last “1” corresponds to a coordinate outside the boundary of the PU. This may be used to indicate that the penultimate element is the last element of the chain

Accordingly, at the receiver (e.g., decoding unit 16 of FIG. 1), the initial “0” will indicate the chains start from the top boundary. The next three bits “011” are encoded to signal the starting position “3” at the top boundary. This “3” may provide the first value for the previous chain index used with Table 1 and represented by idxPre, as discussed above.

The example described with respect to FIG. 8 will generally not require signaling of the total chain number for an N×N PU. This may decrease the number of bits that need to be coded and transmitted. For example, the example of FIG. 8 would not need to code and signal data for the total number of chain elements, which in this example, is seven. In some examples, the maximum number of total chains for an N×N PU may be restricted to be 2N. Accordingly, log₂N+1 bits may be used to signal the number of total chains, the signal data in this example may then be, e.g., 4 bits. The eighth chain element is not within the PU and would not be signaled in an example that signal the total number of chains.

The decoding process for the example illustrated in FIG. 8 using chain coding may generally be the reverse of the encoding process. For example, to decode an N×N PU using chain coding, the following steps are applied:
Step 1: Parse one bit flag start;
Step 2: Parse the start position pos;
Step 3: Parse binarized values representative of directions between elements of the chain. This may be repeated until reaching an element outside the PU;
Step 4: Reconstruct partition pattern pattern which is an N×N binary block;
Step 5: Decode the PU using pattern.

In an example, the pattern may be created determining the value of a flag signaling the start position of the chain. The directions of a series of connected chains, including one additional chain element that may be parsed and the chain element corresponding to a coordinate outside the boundary of the PU. Each chain element may connect a sample (that is, a pixel) and one of its eight-connectivity samples, indexed from 0 to 7, as illustrated in FIG. 7. When the partition pattern, which may be an N×N binary block, is reconstructed the values may be swapped to flip the prediction unit. Flipping the prediction unit up-to-down to may be used to differentiate a top start from a bottom start. This is discussed in more detail below.

FIG. 9 illustrates an example depth PU including a partition pattern. As illustrated in FIG. 9, the series of chain indexes are “3,” “3,” “3,” “7,” “1,” “1,” “1.” The example series (“3,” “3,” “3,” “7,” “1,” “1,” “1,”) provides coding data representative of directions used to identify positions of elements of a chain that partitions a prediction unit of video data. Each of the positions of the elements is within the prediction unit, (e.g., “3,” “3,” “3,” “7,” “1,” “1,” “1,”). In this example, a position that is outside the PU is not used to indicate that the penultimate element is the last element of the chain, as illustrated in FIG. 9. Rather, the encoder codes the total number of chains. In one example, because the total number of chains is larger than 0 the number of chains minus one may be binarized and encoded into the bitstream rather than the number of chains. For example, as illustrated in FIG. 9 four bits “0110” may be coded to signal the total number of chains as 7. Other examples might binarize and encode into the bitstream “0111” or other binary values. This may be used in conjunction with an example that allows for signaling a top boundary, bottom boundary, left boundary, and right boundary, while not providing for signaling of a bit stream that does not includes the number of chain elements.

For example, an encoder may identify the partition pattern and encode the following information in the bitstream:
1. One bit “0” is encoded to signal that the chains start from the top boundary
2. Three bits “011” are encoded to signal the starting position “3” at the top boundary
3. Four bits “0110” are encoded to signal the total number of chains as 7
4. A series of connected chains indexes “3, 3, 3, 7, 1, 1, 1” are encoded, where each chain index is converted to a code word using the look-up-table in Table 1.

The example of FIG. 9 might include aspects that provide for a partition pattern, which includes a partition boundary that intersects with the top, bottom, left, or right boundary, as described below, but codes the total number of chains included in chain coding. Additionally, in some examples, this might be used in units such as either or both of encoding unit 14 and/or decoding unit 16 of FIG. 1.

The decoding process for the examples illustrated in FIG. 11 using chain coding may generally be the reverse of the encoding process. In some examples, this might be used in units such as decoding unit 16 of FIG. 1. For example, to decode an N×N PU using chain coding, the following steps are applied:
Step 1: Parse one bit flag start;
Step 2: Parse the start position pos;
Step 3: Parse number of chain elements, num;
Step 4: Parse num edge code words;
Step 5: Reconstruct partition pattern pattern which is an N×N binary block;
Step 6: Decode the PU using pattern.

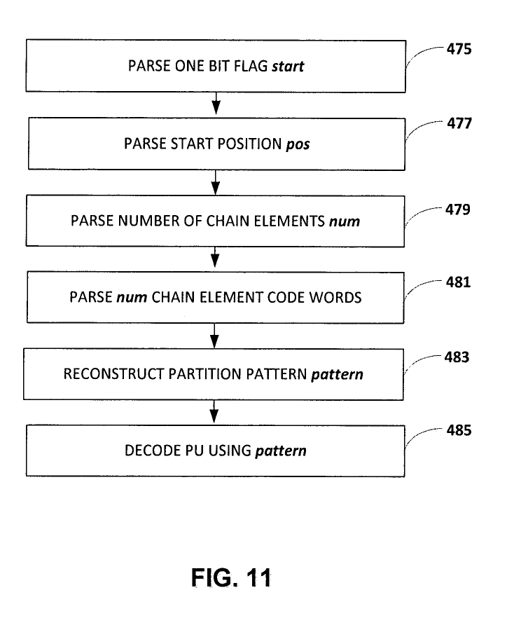

FIG. 10 is a flowchart illustrating an example method in accordance with one or more examples described in this disclosure. In this example, video encoder 20 may perform steps 430 to 442 of the method of FIG. 10, while video decoder 30 may perform steps 444 to 454 of the method of FIG. 10. Although shown as a single method for purposes of explanation, it should be understood that the encoding process and decoding process are not necessarily performed sequentially. For example, a significant amount of time may pass between encoding and decoding, with various intervening steps, such as transfer via a network or broadcast or recording onto a computer-readable medium, such as a DVD, Blu-ray, or other computer-readable media. In an example, intra prediction unit 46 may select contour/chain coding mode for PU (430). When contour/chain coding is selected, video encoder 20 may chain code a block without coding or transmitting data representing the number of elements in the chain.

Partition unit 48 may also partition the PU using chain coding mode (432). For example, intra prediction unit 46 may use the chain to break a PU into two separate regions, as illustrated, for example, in FIG. 5. These separate regions may be generated by determining the value of a flag signaling the start position of the chain and determining the directions of a series of connected chains, including one additional chain element that may be parsed and the chain element corresponding to a coordinate outside the boundary of the PU. Each chain element may connect a sample (that is, a pixel) and one of its eight-connectivity samples, indexed from 0 to 7, as illustrated in FIG. 7.

Intra prediction unit 46 of video encoder 20 may encode data representing chain elements (434). This coding may be performed, for example, by binarizing the data representing the chain elements. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes. The various modes are illustrated in FIG. 4.

Mode select unit 40 may select intra-modes for partitions of PU (436). For example, mode select unit 40 may select one of the coding modes, intra or inter, e.g., based on error results, and provides the resulting intra- or inter-coded block to summer 50 to generate residual block data and to summer 62 to reconstruct the encoded block for use within a reference picture.

Summer 50 may calculate a residual block for PU (438), as illustrated in FIG. 2. Video encoder 20 may transform and quantize residual block (440). For example, transform processing unit 52 may apply a transform (such as a DCT) to pixel values of the residual block to form transform coefficients, and quantization unit 54 may quantize the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Encoder 20 may CABAC encode quantized transform coefficients of residual block (442). For example, entropy coding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks.

Video decoder 30 may CABAC decode quantized transform coefficients of residual block (444). This process may be performed, for example, by entropy decoding unit 70. Accordingly, entropy decoding unit 70 may entropy decodes the bitstream to generate the quantized transform coefficients of residual block.

Inverse quantization unit 58 and inverse transform unit 60 apply inverse quantization and inverse transformation, respectively, to reconstruct the residual block in the pixel domain, e.g., for later use as a reference block (446).

Summer 80 may add the residual block back into the PU as illustrated in FIG. 3 (448) and video decoder 30 may determine intra mode for partitioning the PU (450).

Video decoder 30 may decode the data representative of positions of elements of a chain that partitions a prediction unit of video data (452). Again, each of the positions of the elements except for a last element may be within the prediction unit and the position of the last element may be outside the prediction unit to indicate that the last element is the last element of the chain. Accordingly, video decoder 30 partitions the PU and uses chain coding mode to reproduce the original block (454).

In the example of FIG. 11, a decoder, e.g., decoding unit 16 of FIG. 1 or video decoder 30 of FIG. 3 may parse the one bit flag start to determine which the edge where the chain begins (475). An encoder, e.g., encoding unit 14 of FIG. 1 or encoder 30 of FIG. 3 may perform a reciprocal process to encode the video data, as discussed above. The decoder may also parse the start position pos to determine where on the edge the chain begins (477). The decoder may also parse number of chain elements, num. This is optional. As described herein, some example derive the number of chain elements and/or when each chain element has been processed. The decoder may parse the number of chain element code words, either based on the signaled number, or without such a signaled number as described herein (481). From the chain elements the decoder may reconstruct the partition patter (483) and decode the PU using the pattern (485). As described previously herein, the directions of a series of connected chains, including one additional chain element that may be parsed and the chain element corresponding to a coordinate outside the boundary of the PU. Each chain element may connect a sample (that is, a pixel) and one of its eight-connectivity samples, indexed from 0 to 7, as illustrated in FIG. 7. When the partition pattern, which may be an N×N binary block, is reconstructed the values may be swapped to flip the prediction unit. Flipping the prediction unit up-to-down to may be used to differentiate a top start from a bottom start. This is discussed in more detail below.

Some examples described herein provide for deriving the number of elements in a chain rather than signaling the number of elements in the chain. Signaling the total number of elements in a chain will use log₂N+1 bits for an N×N PU. The number of elements may be removed from the bitstream. One additional element may be parsed and the element corresponding to a coordinate outside the boundary of the PU. The end coordinate (x, y) of each current element may be tracked during and after the parsing of each chain code. When an element's coordinates, after parsing a chain code, is out of the boundary of the PU and the current parsed number of chains is large than 1, the parsing of chain codes terminates.

In some examples, the partition pattern might only intersect with either top or left boundary is included in chain coding. Other examples provide for partition patterns that might intersect with a top boundary, bottom boundary, right boundary, or left boundary. Two bits may be used to signal whether the chains start from top (e.g., 00), left (e.g., 01), bottom (e.g., 10) or right (e.g., 11). In another alternative, when the chains start from bottom, the start position may be initialized in the same way as the chains start from top, and the decoded partition pattern is flipped up and down. When the chains start from right, the start position is initialized in the same way as the chains start from left, the decoded partition pattern is flipped right and left.

Alternatively, 1 bit might be used to indicate starting from the left and 2-bits may be used to indicate starting either from the top or bottom. For example, 0 is indicating left, 10 is indicating top and 11 is indicating bottom. In some cases, when starting from bottom, the chains must end at the right boundary of a PU.

In an example, the derivation of the last chain position and the total number of chains can also be derived based on the number of parsed chain code words until the last chain is identified. In an example, the positions of the elements except for a last element may be within the prediction unit, while the position of the last element is outside the prediction unit. Having the position of the last element outside the prediction unit may indicate that the last element is the last element of the chain. Accordingly, a decoder may track an end coordinate of each chain code word and performing a partitioning process, which is terminated once the additional chain code word, corresponds to the coordinate outside the boundary. For example, a variable may be initialized for storing a total number of chains to 0. In some examples, the partitioning process might not be performed during the decoding of chain code words. For example, the partitioning process may be performed after all of the chain code words are decoded. A previous index, indicating a location on the chain may be initialized to, for example, 3 if the chain starts from either an above boundary or a bottom boundary. If chain does not start from either an above boundary or a bottom boundary the previous index may be initialized to 1.

An example may parse the chain code word to determine an index for the chain code word. Based on the parsed chain code word, the decoder may determine if a position of the chain is on a boundary. This allows the decoder to determine if the penultimate element is the last element of the chain. The total number of chains may also be determined at the decoder based on the penultimate element.

In an example, parsing the chain code word further comprises using a lookup table to determine x and y pixel direction movements based on the chain code word. Additionally, checking to determine if the position of the next chain is on the boundary further comprises setting an x position and a y position based on the x and y pixel direction movements from the lookup table. The position of the next chain is on the boundary when the x position and they position are not within the PU.

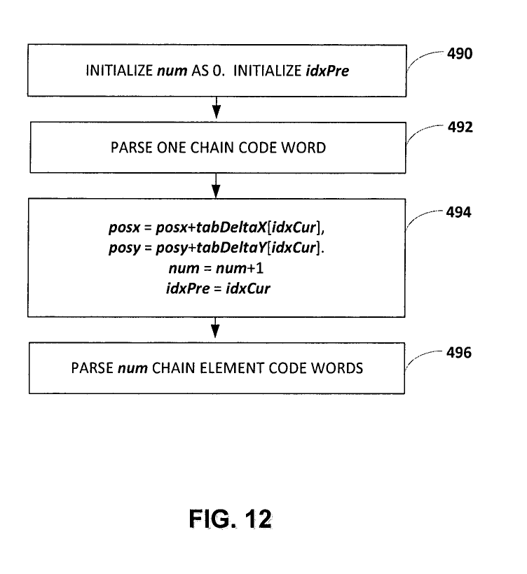

FIG. 12 is a flowchart illustrating the derivation of the last chain position in chain coding. In an example, given the flag start signaling the boundary from which the chains start and start position (posx, posy), the total number of chains num is derived by the following steps:
In step 1 a coder, generally a decoder, may initialize num as 0, and may also initialize idxPre (490). If chains start from above or bottom boundary, set idxPre as 3, otherwise set idxPre as 1;
In step 2 the coder may parse one chain code word as bin Cur, set idxCur as tabIdx[idxPre][binCur] (492);
In step 3 the coder may set posx as posx+tabDeltaX[idxCur], and posy as posy+tabDeltaY[idxCur] and set num as num+1 and set idxPre as idxCur. If “0≦posx<N and 0≦posy<N” or “num≦1, step 2 (492) may be repeated by the coder;
In step 4 the coder may identify the last chain position and set num as num−1. This step is optional.

In the above Step 3, tabDeltaX and tabDeltaY are two pre-defined tables shown in Table 7. The values of tabDeltaX and tabDeltaY in Table 7 provide for movement in the PU along the elements of the chain by mapping changes in x and y positions based on the current index value. In other words, Table 7 provides for x and y changes based on the index 0 to 7 discussed with respect to FIG. 7. For example, an index of “0” which, as illustrated in FIG. 7, is to the left would include a move −1 in the x direction and 0 in the y direction. These are the same values provided by Table 7.

Similarly, for an index of “1” which, is illustrated in FIG. 7, as a movement to the right would include a move 1 in the x direction and 0 in the y direction. For an index of “2” which, is illustrated in FIG. 7, as a movement up would include a move of 0 in the x direction and 1 in the y direction. For an index of “3” which, is illustrated in FIG. 7, as a movement down would include a move of 0 in the x direction and −1 in the y direction. Angular directions, such as directions “4,” “5,” “6,” and “7” are also provided for in Table 7, with x and y values of ±1 depending on the angular direction specified by the index.

TABLE 7
Look-up-table tabDeltaX[idxCur] and
tabDeltaY[idxCur]

| idxCur | 0 | 1 | 2 | 3 | 4 | 5 | 6 | 7 |
|---|---|---|---|---|---|---|---|---|
| tabDeltaX | −1 | 1 | 0 | 0 | −1 | 1 | −1 | 1 |
| tabDeltaY | 0 | 0 | −1 | 1 | −1 | −1 | 1 | 1 |

The flowchart for the derivation of the last chain position in chain coding is shown in FIG. 11. In some examples, this might be used in units such as either or both of encoding unit 14 and/or decoding unit 16 of FIG. 1.

Some examples may support chain coding starting from bottom or right boundary of a PU. When a current PU is encoded using chain coding, two bits may be parsed to provide a two-bit flag start. The flag start identifies the boundary (top, left, bottom or right) from which the chains start.

When the partition pattern pattern, which may be an N×N binary block, is reconstructed the values may be swapped to flip the prediction unit. Flipping the prediction unit up-to-down to may be used to differentiate a top start from a bottom start. This may include, for each i from 0 to and each j from 0 to N−1, swapping value (i, j) with value (N−1−i, j). Similarly, flipping the prediction unit right-to-left may be used to differentiate from a left start or a right start. This may include, for each i from 0 to N−1 and each j from 0 to, swapping value (i,j) with value (N−1−i, j).

Accordingly, the following may be applied, wherein “=” indicates a swap:
If chains start from bottom boundary, for each i from 0 to and each j from 0 to N−1, pattern(i, j)=pattern(N−1−i, j);
If chains start from right boundary, for each i from 0 to N−1 and each j from 0 to, pattern(i, j)=pattern(i, N−1−j).

To perform the swap operation, the following may be performed in the case that the chain starts from the bottom boundary:

temp=pattern (N−1−i, j);
pattern(N−1−i, j)=pattern(i, j);
pattern(i, j)=temp;

Alternatively, in the case that the chain starts from the right boundary, the following may be performed to perform the swap operation:

temp=pattern(i, N−1−j);
pattern(i, N−1−j)=pattern(i, j);
pattern(i, j)=temp;

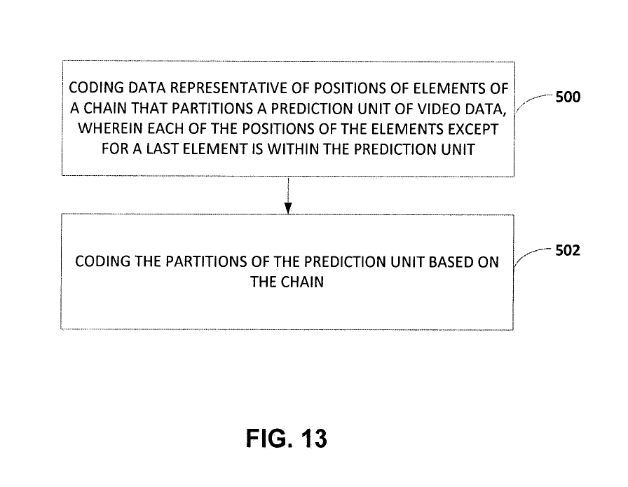

FIG. 13 is a flowchart illustrating an example method in accordance with one or more examples described in this disclosure. An encoder, such as encoding unit 14 or decoder, such as decoding unit 16 may code data representative of the positions of elements of a chain using the method of FIG. 13. The elements of the chain may partition a prediction unit of video data. Additionally, each of the positions of the elements except for a last element may be within the prediction unit. The position of the last element may be outside the prediction unit to indicate that the penultimate element is the last element of the chain (500).

The encoder or decoder may code the partitions of the prediction unit based on the chain (502). For example, a look-up table may provide for the derivation of a chain code word of a chain index. The value of the current chain index and the previous chain index may be used to perform a look-up in the look-up table to determine a chain code word. The value of the previous chain index are the direction index values that indicate data representative of positions of elements of a chain that partitions a prediction unit of video data offset by one. The initial value of the previous chain index used is the starting position of the chain. For example, as discussed above one series of chain indexes as illustrated in FIG. 8 is “3,” “3,” “3,” “7,” “1,” “1,” “1,” “1.” Each chain code word may be binarized as a sequence of binary digits. After each chain code word is binarized, each binary digit may be encoded using an entropy-coding engine. In some examples, this might be used in units such as either or both of encoding unit 14 and/or decoding unit 16 of FIG. 1. The method of FIG. 13 represents an example of a method including coding data representative of positions of elements of a chain that partitions a prediction unit of video data, wherein each of the positions of the elements except for a last element is within the prediction unit, and wherein the position of the last element is outside the prediction unit to indicate that the penultimate element is the last element of the chain; and coding the partitions of the prediction unit based on the chain.

At the decoder, the parsed chain code word and its previous chain index may be used to derive the chain index of current chain. As discussed above, the starting position of the chain may provide an initial value for the previous chain index.

In one or more examples, the functions described may be implemented in hardware, software, firmware, or any combination thereof. If implemented in software, the functions may be stored on or transmitted as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the invention defined by the following claims.

What is claimed is:

1. A method of coding video data, the method comprising:
coding data representative of positions of elements of a chain that partitions a prediction unit of video data, wherein each of the positions of the elements except for a last element is within the prediction unit, and wherein the position of the last element is outside the prediction unit to indicate that the penultimate element is the last element of the chain; and
coding the partitions of the prediction unit based on the chain.

2. The method of claim 1, wherein coding the prediction unit comprises:
encoding data representative of positions of elements of a chain that partitions a prediction unit of video data; and
encoding the partitions of the prediction unit based on the chain.

3. The method of claim 1, wherein coding the prediction unit comprises:
decoding data representative of positions of elements of a chain that partitions a prediction unit of video data; and
decoding the partitions of the prediction unit based on the chain.

4. The method of claim 3, further comprising tracking an end coordinate of each chain code word and the tracking is terminated once the additional chain code word corresponds to the coordinate outside the boundary.

5. The method of claim 4, wherein tracking the end coordinate of each chain code word comprises:
initializing a variable for storing a total number of chains to 0;
initializing a previous index to 3 if the chain start from either an above boundary or a bottom boundary, initializing the previous index to 1 if chain does not start from either an above boundary or a bottom boundary, the previous index comprising a value that indicates a location on the chain;
parsing the chain code word to determine an index for the chain code word;
determining if a position of the chain is on a boundary to determine that the penultimate element is the last element of the chain; and
determining the total number of chains based on the penultimate element.

6. The method of claim 5,
wherein parsing the chain code word further comprises using a lookup table to determine x and y pixel direction movements based on the chain code word;
wherein checking to determine if the position of the next chain is on the boundary further comprises setting an x position and a y position based on the x and y pixel direction movements from the lookup table, wherein the position of the next chain is on the boundary when the x position and they position are not within the boundary of the prediction unit; and
wherein determining the total number of chains further comprises subtracting 1 from the variable for storing the total number of chains when a determination is made that the position of the next chain is on the boundary.

7. The method of claim 1, wherein coding the chain stating position comprises:
coding data indicating whether the chain starts on a horizontal edge or a vertical edge of the prediction unit;
when the data indicates that the chain starts on a vertical edge, coding data indicating whether the chain starts on a left edge or a right edge of the prediction unit; and
when the data indicates that the chain starts on a horizontal edge, coding data indicating whether the chain starts on a top edge or a bottom edge of the prediction unit.

8. The method of claim 1, wherein coding the chain stating position comprises:
creating a partition map that indicates whether pixels of the prediction unit belong to a first partition or a second partition with the chain starting either at the left edge or the top edge based on the data representative of the positions of the elements;
when the chain starts on the right edge, flipping the partition map horizontally; and
when the chain starts on the bottom edge, flipping the partition map vertically.

9. The method of claim 1, wherein coding the chain stating position comprises:
coding data indicating whether the chain starts on a horizontal edge or a vertical edge of the prediction unit; and
flipping a partition map, representative of the positions of the elements, up-to-down to differentiate a top start from a bottom start and flipping the partition map right-to-left to differentiate from a left start or a right start.

10. The method of claim 9, wherein flipping the prediction unit up-to-down to differentiate a top start from a bottom start comprises, for each i from 0 to and each j from 0 to N−1, swapping value (i,j) with value (N−1−i, j) and flipping the prediction unit right-to-left to differentiate from a left start or a right start comprises, for each i from 0 to N−1 and each j from 0 to, swapping value (i,j) with value (N−1−i,j).

11. The method of claim 1, further comprising coding a chain starting position, comprising coding a two bit flag indicating whether the chain starts at a top boundary of the prediction unit, a left boundary of the prediction unit, a bottom boundary of the prediction unit, or a right boundary of the prediction unit.

12. The method of claim 11, wherein a binary value of “00” indicates a top edge, a binary value of “01” indicates a left edge, a binary value of “10” indicates a bottom edge, and a binary value of “11” indicates a right edge.

13. The method of claim 1, wherein 1 bit indicates starting from a left boundary, 2-bits indicate starting from either a top boundary or a bottom boundary.

14. The method of claim 13, wherein when starting from a bottom boundary, the method further comprises ending the chain at a right boundary of the prediction unit.

15. The method of claim 1, wherein coding video data comprises coding data representative of positions of elements of a chain that partitions a prediction unit of video data and the partitions of the prediction unit based on the chain without coding a value indicative of a number of elements in the chain for the prediction unit.

16. A video coder for coding video data comprising one or more processors configured to:
code data representative of positions of elements of a chain that partitions a prediction unit of video data, wherein each of the positions of the elements except for a last element is within the prediction unit, and wherein the position of the last element is outside the prediction unit to indicate that the penultimate element is the last element of the chain; and
code the partitions of the prediction unit based on the chain.

17. The video coder of claim 16, wherein the video coder:
encodes data representative of positions of elements of a chain that partitions a prediction unit of video data; and
encodes the partitions of the prediction unit based on the chain.

18. The video coder of claim 16, wherein the video coder:
decodes data representative of positions of elements of a chain that partitions a prediction unit of video data; and
decodes the partitions of the prediction unit based on the chain.

19. The video coder of claim 18, wherein the one or more processors are configured to track an end coordinate of each chain code word and the tracking is terminated once the additional chain code word corresponds to the coordinate outside the boundary.

20. The video coder of claim 19, wherein the one or more processors are configured to track the end coordinate of each chain code word, wherein the tracking comprises:
initializing a variable for storing a total number of chains to 0;
initializing a previous index to 3 if the chain start from either an above boundary or a bottom boundary, initializing the previous index to 1 if chain does not start from either an above boundary or a bottom boundary, the previous index comprising a value that indicates a location on the chain;
parsing the chain code word to determine an index for the chain code word;
determining if a position of the chain is on a boundary to determine that the penultimate element is the last element of the chain; and
determining the total number of chains based on the penultimate element.

21. The video coder of claim 20,
wherein parsing the chain code word further comprises using a lookup table to determine x and y pixel direction movements based on the chain code word;
wherein checking to determine if the position of the next chain is on the boundary further comprises setting an x position and a y position based on the x and y pixel direction movements from the lookup table, wherein the position of the next chain is on the boundary when the x position and they position are not within the boundary of the prediction unit; and
wherein determining the total number of chains further comprises subtracting 1 from the variable for storing the total number of chains when a determination is made that the position of the next chain is on the boundary.

22. The video coder of claim 16, wherein the one or more processors are configured to:
code data indicating whether the chain starts on a horizontal edge or a vertical edge of the prediction unit;
when the data indicates that the chain starts on a vertical edge, coding data indicating whether the chain starts on a left edge or a right edge of the prediction unit; and
when the data indicates that the chain starts on a horizontal edge, coding data indicating whether the chain starts on a top edge or a bottom edge of the prediction unit.

23. The video coder of claim 16, wherein coding the chain stating position comprises:
creating a partition map that indicates whether pixels of the prediction unit belong to a first partition or a second partition with the chain starting either at the left edge or the top edge based on the data representative of the positions of the elements;
when the chain starts on the right edge, flipping the partition map horizontally; and
when the chain starts on the bottom edge, flipping the partition map vertically.

24. The video coder of claim 16, wherein coding the chain stating position comprises:
coding data indicating whether the chain starts on a horizontal edge or a vertical edge of the prediction unit; and
flipping a partition map, representative of the positions of the elements, up-to-down to differentiate a top start from a bottom start and flipping the partition map right-to-left to differentiate from a left start or a right start.

25. The video coder of claim 24, wherein flipping the prediction unit up-to-down to differentiate a top start from a bottom start comprises, for each i from 0 to and each j from 0 to N−1, swapping value (i, j) with value (N−1−i, j) and flipping the prediction unit right-to-left to differentiate from a left start or a right start comprises, for each i from 0 to N−1 and each j from 0 to, swapping value (i, j) with value (N−1−i,j).

26. The video coder of claim 16, further comprising coding a chain starting position, comprising coding a two bit flag indicating whether the chain starts at a top boundary of the prediction unit, a left boundary of the prediction unit, a bottom boundary of the prediction unit, or a right boundary of the prediction unit.

27. The video coder of claim 16, wherein a binary value of “00” indicates a top edge, a binary value of “01” indicates a left edge, a binary value of “10” indicates a bottom edge, and a binary value of “11” indicates a right edge.

28. The video coder of claim 16, wherein 1 bit indicates starting from a left boundary, 2-bits indicate starting from either a top boundary or a bottom boundary.

29. The video coder of claim 16, wherein when starting from a bottom boundary, ending the chain at a right boundary of the prediction unit.

30. The video coder of claim 16, wherein coding video data comprises coding data representative of positions of elements of a chain that partitions a prediction unit of video data and the partitions of the prediction unit based on the chain without coding a value indicative of a number of elements in the chain for the prediction unit.

31. An apparatus for coding video data, the apparatus comprising:
means for coding data representative of positions of elements of a chain that partitions a prediction unit of video data, wherein each of the positions of the elements except for a last element is within the prediction unit, and wherein the position of the last element is outside the prediction unit to indicate that the penultimate element is the last element of the chain; and
means for coding the partitions of the prediction unit based on the chain.

32. The apparatus of claim 31, comprising:
means for encoding data representative of positions of elements of a chain that partitions a prediction unit of video data, wherein each of the positions of the elements except for a last element is within the prediction unit, and wherein the position of the last element is outside the prediction unit to indicate that the penultimate element is the last element of the chain; and
means for encoding the partitions of the prediction unit based on the chain.

33. The apparatus of claim 31, comprising:
means for decoding data representative of positions of elements of a chain that partitions a prediction unit of video data, wherein each of the positions of the elements except for a last element is within the prediction unit, and wherein the position of the last element is outside the prediction unit to indicate that the last element is the last element of the chain; and
means for decoding the partitions of the prediction unit based on the chain.

34. The apparatus of claim 33, comprising means for tracking an end coordinate of each chain code word and the tracking is terminated once the additional chain code word corresponds to the coordinate outside the boundary.

35. The apparatus of claim 34, comprising:
means for initializing a variable for storing a total number of chains to 0;
means for initializing a previous index to 3 if the chain start from either an above boundary or a bottom boundary, means for initializing the previous index to 1 if chain does not start from either an above boundary or a bottom boundary, the previous index comprising a value that indicates a location on the chain;
means for parsing the chain code word to determine an index for the chain code word;
means for determining if a position of the chain is on a boundary to determine that the penultimate element is the last element of the chain; and
means for determining the total number of chains based on the penultimate element.

36. The apparatus of claim 35,
wherein the means for parsing the chain code word further comprises using a lookup table to determine x and y pixel direction movements based on the chain code word;
wherein checking to determine if the position of the next chain is on the boundary further comprises means for setting an x position and ay position based on the x and y pixel direction movements from the lookup table, wherein the position of the next chain is on the boundary when the x position and the y position are not within the boundary of the prediction unit; and
wherein the means for determining the total number of chains further comprises subtracting 1 from the variable for storing the total number of chains when a determination is made that the position of the next chain is on the boundary.

37. The apparatus of claim 31, comprising:
means for coding data indicating whether the chain starts on a horizontal edge or a vertical edge of the prediction unit;
when the data indicates that the chain starts on a vertical edge, means for coding data indicating whether the chain starts on a left edge or a right edge of the prediction unit; and
when the data indicates that the chain starts on a horizontal edge, means coding data indicating whether the chain starts on a top edge or a bottom edge of the prediction unit.

38. The apparatus of claim 31, comprising:
means for creating a partition map that indicates whether pixels of the prediction unit belong to a first partition or a second partition with the chain starting either at the left edge or the top edge based on the data representative of the positions of the elements;
means for flipping, when the chain starts on the right edge, the partition map horizontally; and
means for flipping, when the chain starts on the bottom edge, the partition map vertically.

39. The apparatus of claim 31, further comprising means for coding data representative of positions of elements of a chain that partitions a prediction unit of video data and the partitions of the prediction unit based on the chain without coding a value indicative of a number of elements in the chain for the prediction unit.

40. A computer program product comprising a computer-readable storage medium having stored thereon instructions that, when executed, cause one or more processors of a device to perform the following steps:
code data representative of positions of elements of a chain that partitions a prediction unit of video data, wherein each of the positions of the elements except for a last element is within the prediction unit, and wherein the position of the last element is outside the prediction unit to indicate that the penultimate element is the last element of the chain; and
code the partitions of the prediction unit based on the chain.

41. The computer program product of claim 40, wherein the computer-readable storage medium further includes instructions that, when executed, cause one or more processors of the device to perform the following steps:
encode data representative of positions of elements of a chain that partitions a prediction unit of video data, wherein each of the positions of the elements except for a last element is within the prediction unit, and wherein the position of the last element is outside the prediction unit to indicate that the penultimate element is the last element of the chain; and
encode the partitions of the prediction unit based on the chain.

42. The computer program product of claim 40, wherein the computer-readable storage medium further includes instructions that, when executed, cause one or more processors of a device to perform the following steps:
decode data representative of positions of elements of a chain that partitions a prediction unit of video data, wherein each of the positions of the elements except for a last element is within the prediction unit, and wherein the position of the last element is outside the prediction unit to indicate that the last element is the last element of the chain; and
decode the partitions of the prediction unit based on the chain.

43. The computer program product of claim 42, wherein the computer-readable storage medium further includes instructions that, when executed, cause one or more processors of a device to track an end coordinate of each chain code word and the tracking is terminated once the additional chain code word corresponds to the coordinate outside the boundary.

44. The computer program product of claim 43, wherein the computer-readable storage medium includes instructions that, when executed, cause one or more processors of a device to:
initialize a variable for storing a total number of chains to 0;
initialize a previous index to 3 if the chain start from either an above boundary or a bottom boundary, initializing the previous index to 1 if chain does not start from either an above boundary or a bottom boundary, the previous index comprising a value that indicates a location on the chain;
parse the chain code word to determine an index for the chain code word;
determine if a position of the chain is on a boundary to determine that the penultimate element is the last element of the chain; and
determine the total number of chains based on the penultimate element.

45. The computer program product of claim 44, wherein the computer-readable storage medium further includes instructions that, when executed, cause one or more processors of a device to perform the following steps:
use a lookup table to parse the chain code word further comprises to determine x and y pixel direction movements based on the chain code word;
set an x position and a y position based on the x and y pixel direction movements from the lookup table, wherein the position of the next chain is on the boundary when the x position and they position are not within the boundary of the prediction unit to check to determine if the position of the next chain is on the boundary further comprises; and
subtract 1 from the variable for storing the total number of chains when a determination is made that the position of the next chain is on the boundary to determine the total number of chains.

46. The computer program product of claim 40, wherein the computer-readable storage medium further includes instructions that, when executed, cause one or more processors of a device to perform the following steps:
code data indicating whether the chain starts on a horizontal edge or a vertical edge of the prediction unit;
code data indicating whether the chain starts on a left edge or a right edge of the prediction unit when the data indicates that the chain starts on a vertical edge; and
code data indicating whether the chain starts on a top edge or a bottom edge of the prediction unit when the data indicates that the chain starts on a horizontal edge.

47. The computer program product of claim 40, wherein the computer-readable storage medium further includes instructions that, when executed, cause one or more processors of a device to perform the following steps:
create a partition map that indicates whether pixels of the prediction unit belong to a first partition or a second partition with the chain starting either at the left edge or the top edge based on the data representative of the positions of the elements;
flip the partition map horizontally when the chain starts on the right edge; and
flip the partition map vertically when the chain starts on the bottom edge.

48. The computer program product of claim 40, wherein the computer-readable storage medium further includes instructions that, when executed, cause one or more processors of a device to code data representative of positions of elements of a chain that partitions a prediction unit of video data and the partitions of the prediction unit based on the chain without coding a value indicative of a number of elements in the chain for the prediction unit to code video data.
